(19) United States
(12) Patent Application Publication
(10) Pub. No.: US 2011/0282759 A1
(43) Pub. Date: Nov. 17, 2011

(54) SYSTEMS AND METHODS FOR PERFORMING AN ACTION ON A PROGRAM OR ACCESSING THE PROGRAM FROM A THIRD-PARTY MEDIA CONTENT SOURCE

(75) Inventors: Janeen Levin, Pacifica, CA (US); Brian Fife, Somerville, MA (US)

(73) Assignee: ROVI TECHNOLOGIES CORPORATION, Santa Clara, CA (US)

(21) Appl. No.: 12/779,513

(22) Filed: May 13, 2010

(51) Int. Cl. H04N 5/445; G06F 15/16; G06Q 30/00

(52) U.S. Cl. 705/26.41; 709/217; 725/39; 725/44

(57) ABSTRACT

A program may be selected from a list of programs that is presented to the user. It may be determined whether the selected program is scheduled to be broadcast by a first media content source within a certain pre-determined time period. If the selected program is scheduled to be broadcast by the first media content source within the pre-determined time period, then the user may be provided with an opportunity to perform a certain action on the program. On the other hand, if the selected program is not scheduled to be broadcast within the pre-determined time period, the user may be provided with an opportunity to access the program from a third-party media content source.

### BACKGROUND OF THE INVENTION

Media content is currently available to individuals from a wide range of sources in many different forms. For example, a single user may choose to watch a program on their home television equipment while the program is being broadcast, watch the program on their computer using a Website like Hulu, download the program using from an application like iTunes, purchase a digital versatile disc (“DVD”) containing an entire season of the program from Amazon, or rent a DVD of the containing episodes of the program from a rental service like Netflix or Blockbuster. Similar options are available for many movies, which will also be referred to herein as “programs” for convenience. Currently available applications typically assist the user in watching or obtaining copies of programs from only one of these sources. Accordingly, there exists a need for systems and methods that will assist a user in coordinating the various options available to her in watching or otherwise accessing programs of interest.

Additionally, various techniques exist for identifying programs that may be of interest to a given user. For instance, an interactive media guidance application operating on a user's set-top box may recommend programs that are similar to (e.g., relate to the same topic as) other programs that the user has designated as favorites or has recently watched or recorded. As another example, the interactive media guidance application may utilize statistics (e.g., gathered by a service provider, a content provider, or any other source) suggesting that users who like a first program often like a second program, without explicitly identifying the reason for the association. Despite the usefulness of such recommendation techniques, they often fail to leverage entire categories of data that the user has provided to third parties that may be indicative of programs that the user may be interested in. Conversely, third parties often do not take advantage of information that the user has supplied to an interactive media guidance application that may be indicative of general interests that the user may have. Thus, there exists a need for systems and methods to more effectively share information between content sources and between applications, in order to more effectively tailor how content is provided to the user.

### SUMMARY OF THE INVENTION

Systems and methods are provided for integration of media guidance applications with third-party sources of data and content in accordance with embodiments of the invention.

In some embodiments, a program may be selected from a list of programs that is presented to the user. The list may be generated in any suitable way, such as by performing a stand-alone program search for all programs with titles containing a certain string of characters or by retrieving a list of all programs in which an actor has appeared. It may be determined whether the selected program is scheduled to be broadcast by a first media content source (e.g., associated with a user's primary television service provider) within a certain pre-determined time period, such as a week. If the selected program is scheduled to be broadcast by the first media content source within the pre-determined time period, then the user may be provided with an opportunity to perform a certain action on the program, such as record the program when it airs or set a reminder for the program. On the other hand, if the selected program is not scheduled to be broadcast within the pre-determined time period, the user may be provided with an opportunity to access the program from a third-party media content source, such as by placing the program on the user's Netflix queue or by purchasing a DVD of the program from Amazon.

In some embodiments, information corresponding to a user may be received from a third-party data source. As an example, the information may indicate which movies have been listed as favorites or been rated relatively well by a user's Facebook friends. A program may be identified using the information received from the third-party data source. Then, it may be determined whether the identified program is scheduled to be broadcast by a first media content source (e.g., associated with a user's primary television service provider) within a pre-determined time period, such as a week. If the identified program is scheduled to be broadcast by the first media content source within the pre-determined time period, an opportunity may be provided to perform an action on the program, such as record it or set a reminder for it.

In some embodiments, a user may receive content (or information relating to content) using applications called “widgets.” Widgets are applications separate from the primary interactive media guidance application (e.g., electronic program guide) of the user's main content service provider, and may often access information through the Internet. Widgets, advantageously, are usually smaller than full-featured media guidance applications and are thus capable of running not only on devices such as personal computers or set-top boxes, but also on less computationally powerful devices such as a user's television. As one illustrative example, a Yahoo! News widget may provide a user with access to current online news articles through the user's television. According to some embodiments of the invention, information may be shared between multiple widgets operating on the same user equipment. Information corresponding to a user may be received from a first widget operating on the user equipment and made accessible to a second widget operating on that user equipment. For example, information indicating that the user is interested in a particular actor may be received from a TV Guide widget and shared with a Yahoo! News widget. The received information may then be used to customize a manner in which the second widget provides content to the user. Continuing with the Yahoo! News example, news articles relating to the actor of interest may be retrieved and presented to the user.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative media guidance screen in accordance with embodiments of the invention;

FIG. 2 shows a second illustrative media guidance screen in accordance with embodiments of the invention;

FIG. 3 shows an illustrative user equipment device in accordance with embodiments of the invention;

FIG. 4 shows an illustrative content delivery system in accordance with embodiments of the invention;

FIG. 5 shows an illustrative service provider setup screen in accordance with embodiments of the invention;

FIG. 6 shows an illustrative third-party setup screen in accordance with embodiments of the invention;

FIG. 7 shows an illustrative third-party options screen in accordance with embodiments of the invention;

FIG. 8 shows an illustrative favorites designation screen in accordance with embodiments of the invention;

FIG. 9 shows an illustrative screen with a widget navigation menu in accordance with embodiments of the invention;

FIG. 10 shows an illustrative media guidance widget screen allowing navigation through program listings in accordance with embodiments of the invention;

FIG. 11 shows an illustrative program information screen in accordance with embodiments of the invention;

FIG. 12 shows an illustrative cast member list screen in accordance with embodiments of the invention;

FIG. 13 shows an illustrative actor information screen in accordance with embodiments of the invention;

FIG. 14 shows an illustrative actor credits screen in accordance with embodiments of the invention;

FIG. 15 shows an illustrative program action screen in accordance with embodiments of the invention;

FIG. 16 shows an illustrative third-party access screen in accordance with embodiments of the invention;

FIG. 17 shows an illustrative recommendations screen in accordance with embodiments of the invention;

FIG. 18 shows an illustrative actor news screen in accordance with embodiments of the invention;

FIG. 19 shows an illustrative news articles screen in accordance with embodiments of the invention;

FIG. 20 shows an illustrative flow chart of a first part of a process for providing an opportunity to perform an action on a program or to access the program from an third-party media content source in accordance with embodiments of the invention;

FIG. 21 shows an illustrative flow chart of a second part of a process for providing an opportunity to perform an action on a program or to access the program from an third-party media content source in accordance with embodiments of the invention;

FIG. 22 shows an illustrative flow chart of a process for providing an opportunity to perform an action on a program that is identified using information from an third-party data source in accordance with embodiments of the invention; and

FIG. 23 shows an illustrative flow chart of a process for sharing information between a plurality of widgets operating on user equipment in accordance with embodiments of the invention.

### DETAILED DESCRIPTION OF THE VARIOUS EMBODIMENTS

Embodiments of the present invention advantageously permit integration of media guidance applications with third-party sources to better customize user access to media and other content. For example, if a program of interest to the user is being broadcast by the user's service provider within a certain time period (e.g., the next seven days), the user may be given the option to record or set a reminder for that program. However, if the program will not be broadcast by that primary service provider within that time period, the user may be given options to access the program from third-party sources, such as by purchasing, renting, or downloading the program.

As another example, information that may be helpful in determining recommendations for the user may be extracted from third-party sources such as social networking sites or sources that provide media for purchase, renting, or download. A recommendation that is generated using such information may then be presented to the user if it is determined that the recommended program will be broadcast by the user's primary content service provider within a certain time period.

As yet another example, widgets operating on the same user equipment may communicate with each other and exchange information in order to better customize the content provided to the user by each widget. So, for instance, a news widget may access information about a user's favorite actors from a media guidance widget in order to present news articles about that actor to the user. Alternatively, or in addition, access to content of the second widget may be provided directly within an interface of the first widget, so that the user may navigate through widgets in a more seamless way, instead of being forced to select the second widget from a widget navigation menu to view a different type of content.

Many of the illustrative examples described herein will be discussed in connection with the primary, full-featured interactive media guidance application (e.g., an electronic program guide) that may be provided by a service provider, or in connection with another application such as a widget. However, it will be appreciated that concepts of the invention can be implemented on the primary interactive media guidance application, a widget, or both, and the invention will generally not be limited to any particular type of application. Indeed, certain types of widgets may facilitate media guidance and can rightfully be viewed as a particular type of interactive media guidance application. Additionally, certain interactive media guidance applications may include functionality that is traditionally found in widgets (e.g., communication with third-party content sources via the Internet). In some embodiments, a single algorithm may include steps performed by a widget and steps performed by the primary interactive media guidance application, thus requiring communication between the widget and the guidance application. As an example, a user may browse program information on a media guidance widget and, upon discovering that the program will be broadcast in the near future, submit a command to record the program using the primary media guidance application. Thus, statements made herein characterizing interactive media guidance applications will apply to widgets that perform media guidance functions, when appropriate.

In general, interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (“VOD”) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (“PCs”) and other devices on which they traditionally did not, such as hand-held computers, personal digital assistants (“PDAs”), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

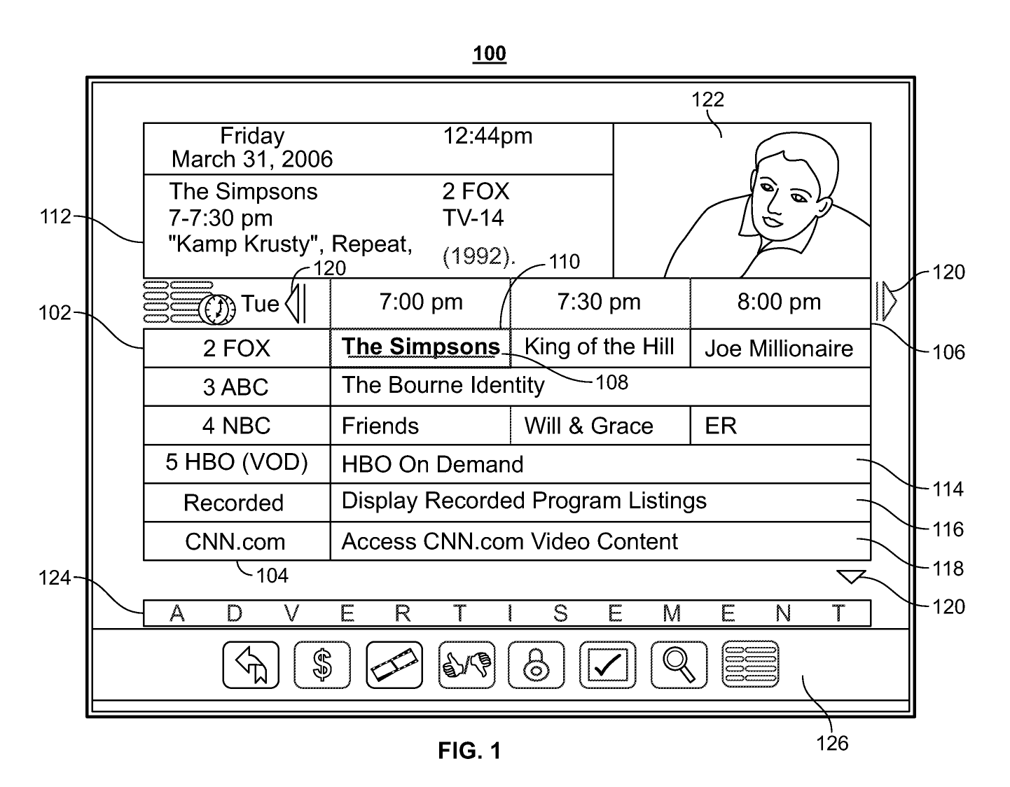

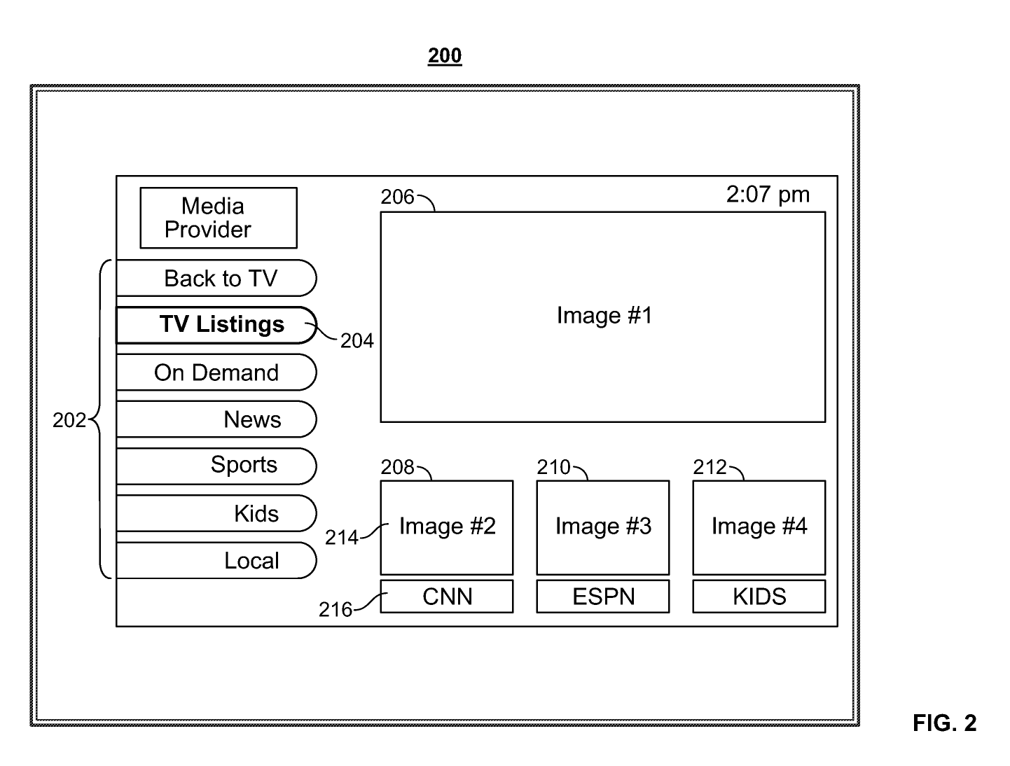

One of the functions of the media guidance application is to provide media listings and media information to users. FIGS. 1-2 show illustrative display screens that may be used to provide media guidance, and in particular media listings. The display screens shown in FIGS. 1-2 and 5-19 may be implemented on any suitable device or platform. While the displays of FIGS. 1-2 and 5-8 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (“DVR”), digital video disc (“DVD”), video cassette, compact disc (“CD”), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (“PIG”) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

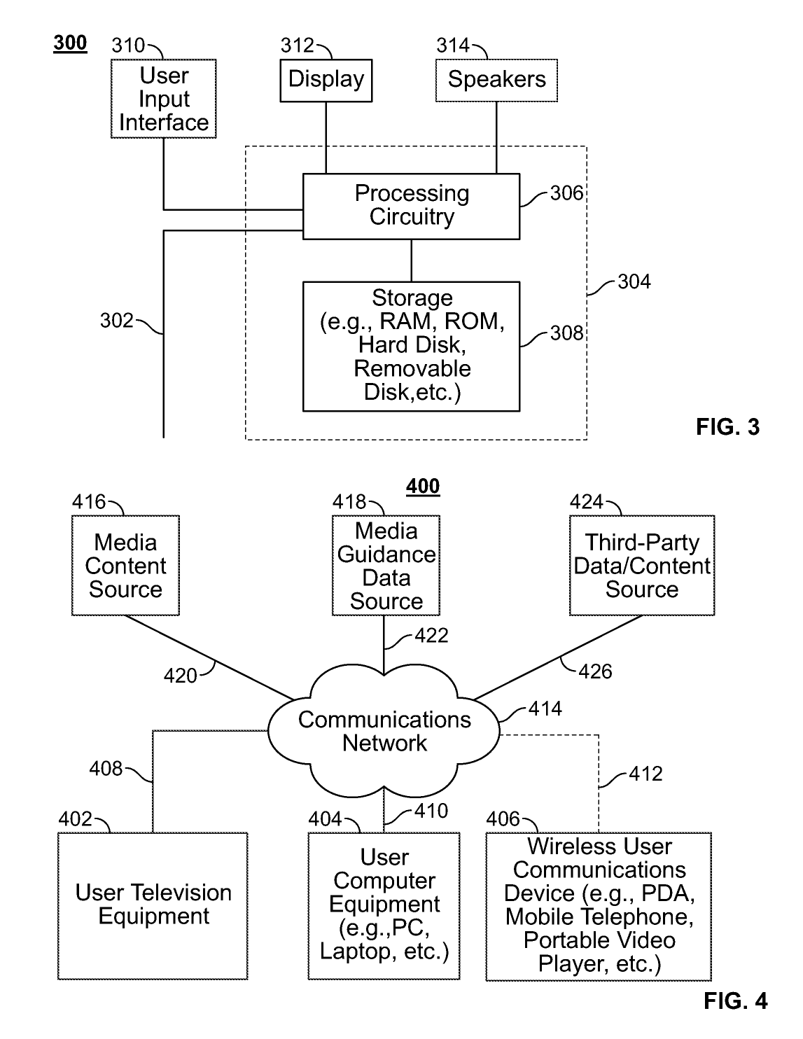

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (“I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (“ISDN”) modem, a digital subscriber line (“DSL”) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (“PIP”) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (“LCD”) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (“EBIF”), received by control circuitry 304 as part of a suitable feed, and interpreted by a user agent running on control circuitry 304. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

One or more widgets may be implemented on user equipment device 300 in any suitable manner (e.g., using any of the architectures described above in connection with the guidance application). For example, if user equipment device 300 includes a television and a set-top box, one or more widgets can be implemented in the set-top box, in the television, or both. Widgets implemented at least partially on user equipment device 300 may allow the user to interact with Web services via the Internet while watching television. These widgets may provide the user with access to television program listings, news, financial data, pictures, social networking applications, movie rental services, consumer products available for purchase, or any other suitable content or combinations thereof. In some embodiments, these widgets may run on the Yahoo! Connected TV platform, and display 312 may include or be part of a television manufactured with built-in support for widgets from one of Samsung Group, Sony Group, LG Electronics, or Vizio.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (“IRD”) for handling satellite television, a television set, a digital storage device, a DVD recorder, a video-cassette recorder (“VCR”), a local media server, or other user television equipment. One or more of these devices may be integrated to be a single device, if desired. User computer equipment 404 may include a PC, a laptop, a tablet, a WebTV box, a personal computer television (“PC/TV”), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416, media guidance data source 418, and third-party data/content source 424 coupled to communications network 414 via communication paths 420, 422, and 426, respectively. Paths 420, 422, and 426 may include any of the communication paths described above in connection with paths 408, 410, and 412. Communications with the media content source 416, media guidance data source 418, and third-party data/content source 424 may be exchanged over one or more communications paths, but are shown as a single path in FIG. 4 to avoid overcomplicating the drawing. In addition, there may be more than one of each of media content source 416, media guidance data source 418, and third-party data/content source 424 but only one of each is shown in FIG. 4 to avoid overcomplicating the drawing. (The different types of each of these sources are discussed below.) If desired, any combination of media content source 416, media guidance data source 418, and third-party data/content source 424 may be integrated as one source device. Although communications between sources 416, 418, and 424 with user equipment devices 402, 404, and 406 are shown as through communications network 414, in some embodiments, sources 416, 418, and 424 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Third-party data/content source 424 may include similar types of equipment and provide similar types of data and content as media content source 416 and media guidance data source 418, except the data and content that is provided by third-party data/content source 424 will not originate from the user's primary media service provider. Third-party data/content source 424 may provide any suitable content or data, including but not limited to news articles, financial data on public companies, weather forecasts, photos, consumer products, social networking data and applications, and downloads and physical copies (e.g., DVDs and CDs) of television episodes, movies, video clips, and music, as well as any other suitable data/content and combinations thereof. In accordance with embodiments of the invention, data and content from third-party data/content source 424 may be used by media guidance applications and widgets operating at least partially on user equipment devices 402, 404, and 406. In practice, many third-party sources 424 may be included in system 400, but only one is depicted to avoid overcomplicating the figure.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

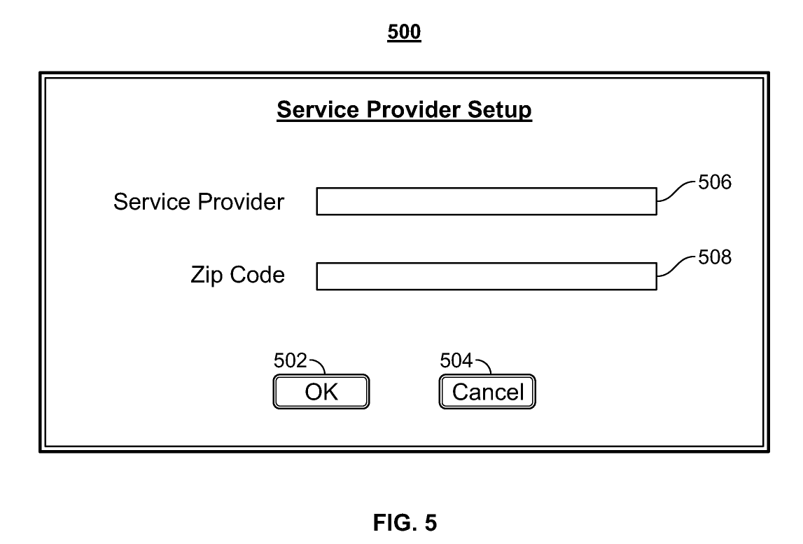

FIG. 5 shows an illustrative service provider setup screen 500 in accordance with embodiments of the invention. Service provider setup screen 500 may be displayed by an interactive media guidance application, a widget, or a system running a guidance application or widget. The user may enter a name or other identifier for their primary media content provider (e.g., Time Warner Cable) in field 506 using any suitable techniques, such as selection from a drop-down menu, prefix searching using a letter array that is displayed when field 506 is selected, entry of a unique numerical code provided to the user by the primary media content provider, or any other suitable technique or combinations thereof. The user may also enter in field 508 the zip code in which they reside or are currently using media guidance services, again using any appropriate means, such as numerical keys on their input device or selecting from a number array that is displayed when field 508 is selected. Once the requested data has been entered, the user may register the information by selecting “OK” button 502, or may return to the previous screen by selecting “Cancel” button 504.

In some embodiments, the service provider and zip code provided by the user may be used by various widgets, including media guidance widgets, to help determine which programs will be broadcast by the user's primary media service provider in a certain time period (e.g., the next week), thereby allowing the widgets to determine opportunities to view, record, or set reminders for such programs or, if the programs will not be broadcast in that time period, determine opportunities to access the programs from other sources such as third parties. In other embodiments, service provider setup screen 500 may be displayed automatically by widgets that may require or optionally use service provider information. In other embodiments, service provider setup screen 500 is only displayed when the user wishes to enable functionality that relies upon service provider information. Service provider setup screen 500 may also be used by interactive media guidance applications provided by the user's primary media service provider, although manual input of such information into the interactive media guidance application may not be necessary. In yet other embodiments, widgets that may require or wish to use service provider information may automatically detect such information or may be supplied with such information through other techniques.

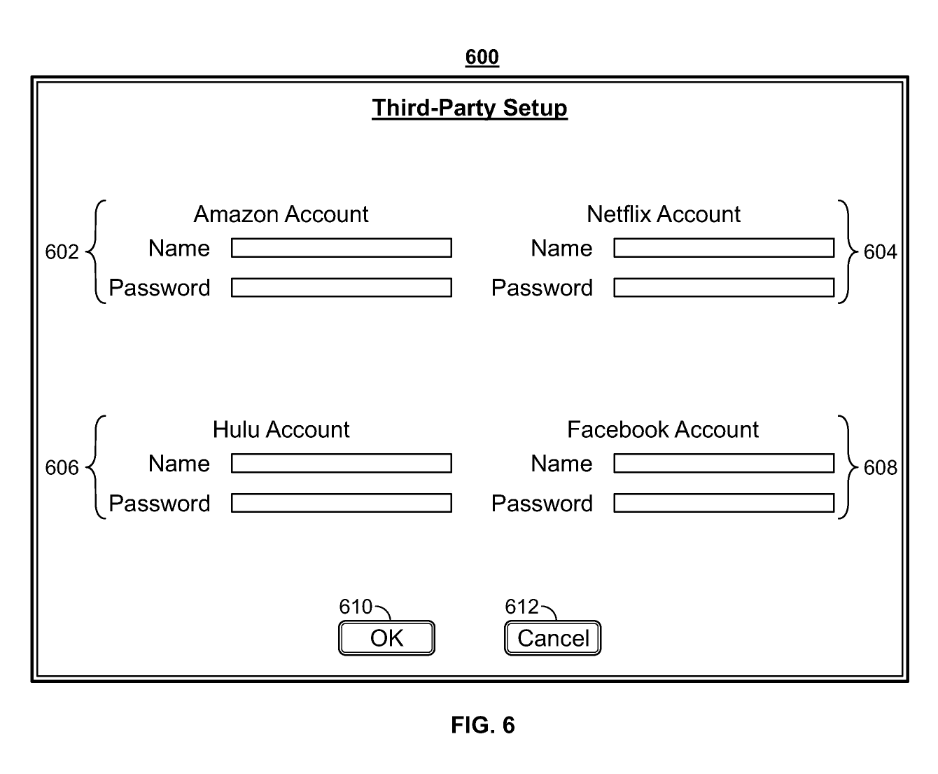

FIG. 6 shows an illustrative third-party setup screen 600 in accordance with embodiments of the invention. Third-party setup screen 600 may be displayed by an interactive media guidance application, a widget, or a system running a guidance application or widget. In this example, name-and-password entry areas 602, 604, 606, and 608 allow a user to input account login information for Amazon, Netflix, Hulu, and Facebook, respectively. It will be appreciated that the particular third-party sources may vary, and the invention is not limited in this respect. The layout and number of name-and-password entry areas in third-party setup screen 600 may similarly be varied without deviating from the spirit or scope of the present invention. Names and passwords may be entered in any suitable manner, including using any of the techniques described above in connection with FIG. 5.

Third-party setup screen 600 advantageously permits one-time entry of account information that will later permit widgets and media guidance applications to easily access data and content from, and perform transactions with, a user's third-party accounts without prompting the user to enter account login information each time such access or transactions need to be performed. For instance, if a user wishes to watch a program that will not be broadcast by the user's primary media service provider in the near future, the user may opt to obtain the program from any of the third parties whose login information is entered in third-party setup screen 600. Third-party setup screen 600 may be displayed automatically by guidance applications or widgets, or may be displayed only after a user has enabled or attempted to use functionality that requires interaction with such third parties. Once the appropriate account login information is entered for some or all of the relevant third parties, the user may register the information by selecting “OK” button 610. Alternatively, the user may return to the previous screen by selecting “Cancel” button 612.

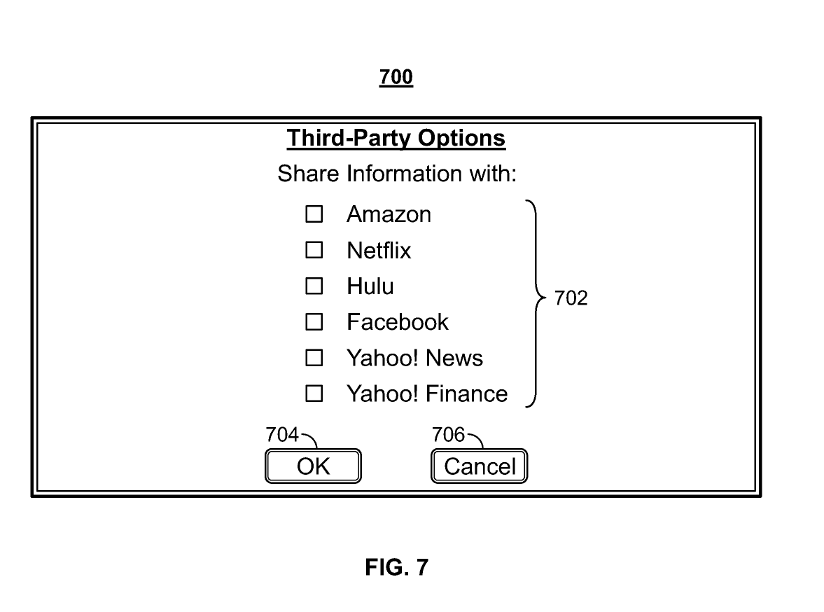

FIG. 7 shows an illustrative third-party options screen 700 in accordance with embodiments of the invention. Third-party options screen 700 may be displayed by an interactive media guidance application, a widget, or a system running a guidance application or widget. Third-party options screen 700 permits a user to enable a given widget, media guidance application, or system to exchange information and perform transactions with various third parties by selecting from among third-party entries 702. Other suitable third parties and selection techniques may be used. Third-party options screen 700 may be displayed at any suitable times, such as upon first launch of the corresponding media guidance widget or guidance application, before or after display of third-party setup screen 600, upon selection of various related options by a user, or any other suitable times or combinations thereof.

In the example depicted in FIG. 7, the user may opt to exchange information with any or all of an online retailer such as Amazon, a media rental service such as Netflix, a media viewing portal such as Hulu, a social networking service such as Facebook, a news service such as Yahoo! News, and a financial information service such as Yahoo! Finance. For example, the user may enable a media guidance widget or guidance application to exchange information with Amazon, Netflix, or Hulu to permit the user to buy, rent, or view programs of interest, or to detect programs of interest using information that has been provided to any of those third parties. Similarly, the user may permit a media guidance widget or guidance application to detect programs or actors that have been listed as favorites or highly rated by the user's friends on Facebook, or to share a favorite program or actor with their Facebook friends. Additionally, the user may allow a media guidance widget or guidance application to share information with a Yahoo! News widget or Yahoo! Finance widget, in order to retrieve news or financial information pertaining to actors or programs that the user has identified as favorites, viewed or recorded (in the case of programs), or otherwise identified, explicitly or implicitly, using the media guidance widget or guidance application. The user may register the user's preferences by selecting “OK” button 740 or may return to the previous screen by selecting “Cancel” button 706. In some embodiments, third-party options similar to those shown in third-party options screen 700 may be configured using an Internet site, rather than directly in an application or widget operating on user equipment 300. The Internet site may be accessed in any suitable way, such as by using a Web browser operating on user equipment 300 or on other user equipment that the user may have access to.

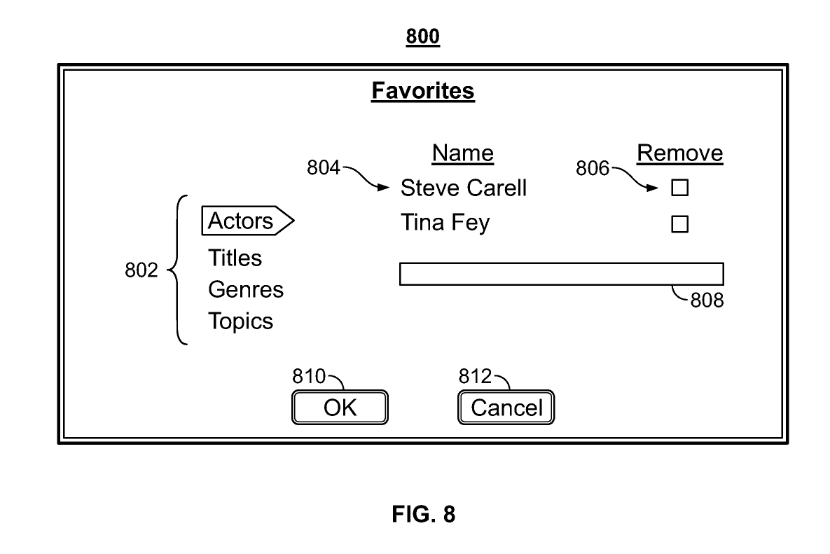

FIG. 8 shows an illustrative favorites designation screen 800 in accordance with embodiments of the invention. Favorites designation screen 800 may be displayed by an interactive media guidance application, a widget, or a platform or system running a guidance application or widget. A user may choose to enter information pertaining to favorite actors, titles, genres, and topics using left-hand navigation menu 802. The categories listed are merely illustrative, and other categories may be used. In the example illustrated, the user has chosen to enter information on favorite actors. Names of current favorite actors are listed in names 804, and any particular name may be removed using any of checkboxes 806. New favorite actors may be added using name entry field 808, which may accept text input using any of the techniques discussed above in connection with FIG. 5. The layout and interface depicted in FIG. 8 are merely illustrative, and other possibilities are contemplated.

Once this information is entered, it may be used not only by the media guidance widget or guidance applications that displays favorites designation screen 800 (e.g., to provide recommendations for programs), but possibly by other widgets or applications, or by various third-party sources, in accordance with embodiments of the invention. Entries may be finalized by selecting “OK” button 810 or cancelled by selecting “Cancel” button 812.

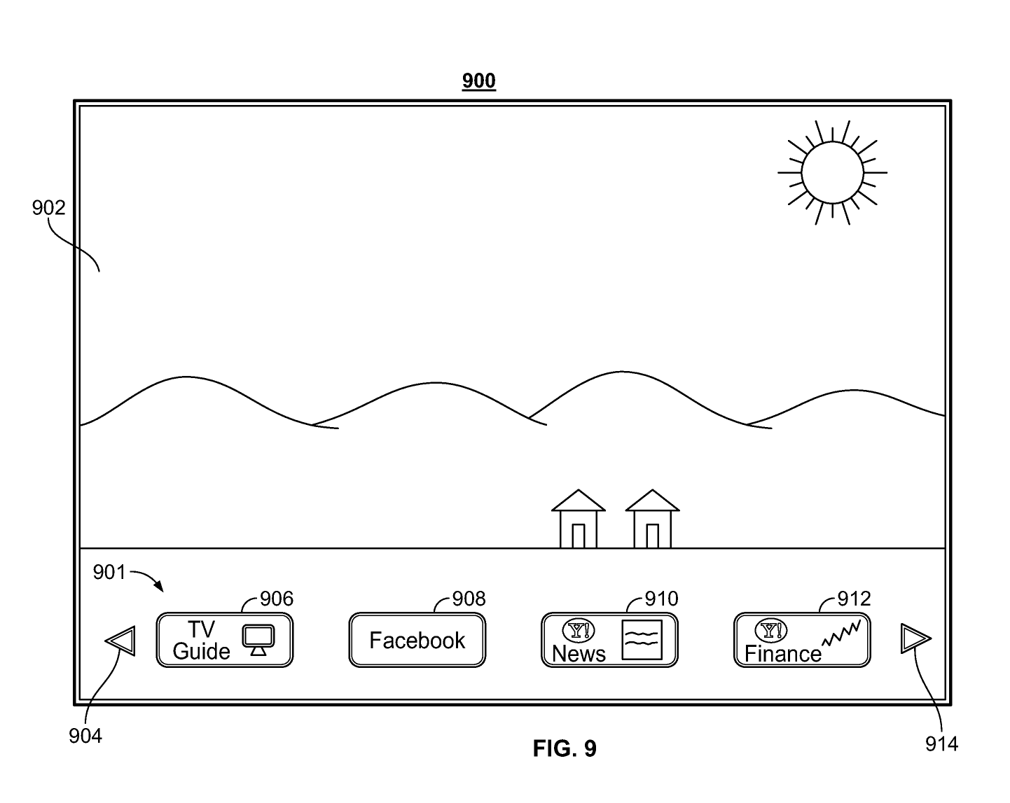

FIG. 9 shows an illustrative screen 900 with widget navigation menu 901 in accordance with embodiments of the invention. Screen 900 may include main region 902, depicting a program that is currently being broadcast or a recorded program that is currently being played back. Widget navigation menu may be accessed in any suitable way, such as by pressing a dedicated widget button on user input interface 310 (FIG. 3), by selecting a widget option in an interactive media guidance application, by pressing a dedicated widget button or navigating through appropriate menus in a television or other user equipment, or through any other suitable techniques or combinations thereof. Once accessed, widget navigation menu 901 may display an array of widget icons 906, 908, 910, and 912. In the example shown in FIG. 9, these icons correspond respectively to a media guidance widget (e.g., from TV Guide), a social networking widget (e.g., from Facebook), a news widget (e.g., from Yahoo! News), and a finance widget (e.g., from Yahoo! Finance).

A user may scroll through widget navigation menu 901 in any suitable way, including using directional arrow keys in user input interface 310 (FIG. 3), using arrow icons 904 and/or 914 to access additional widgets that cannot fit on screen 900, or with any other suitable technologies or combinations thereof. In some embodiments, the currently selected widget icon may be shown as larger than the others, marked with a highlight region (e.g., similar to highlight region 110 (FIG. 1)), distinguished with a color scheme different from the scheme used with other widgets (e.g., color as opposed to black and white), or marked in any other suitable manner. The widget corresponding to the currently selected icon may be launched by choosing the icon with user input interface 310 (FIG. 3). Widget navigation menu 910 is merely illustrative, and other layouts and interfaces are contemplated.

In this example, each widget may provide one particular type of content or service, but embodiments are contemplated where widgets may integrate two or more types of content. Further, as discussed in more detail below, it is contemplated that one widget may provide direct access (e.g., via a link within that widget) to other widgets in accordance with embodiments of the invention, thus avoiding the need to pull up and scroll through widget navigation menu 901 each time access to a new widget is desired.

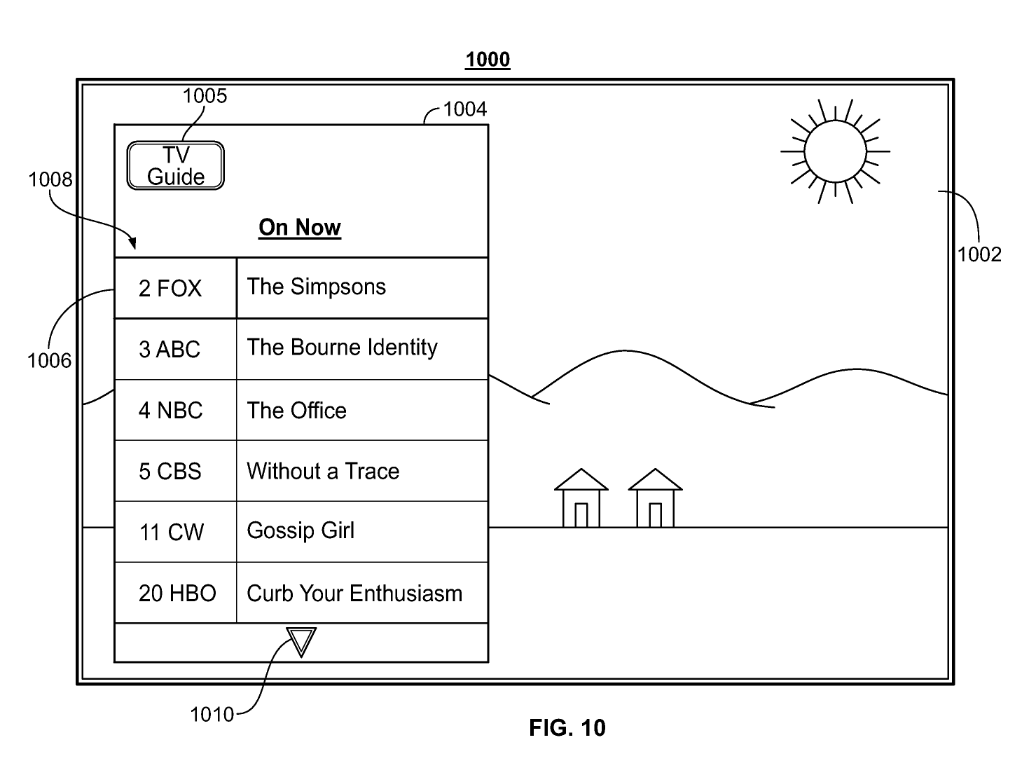

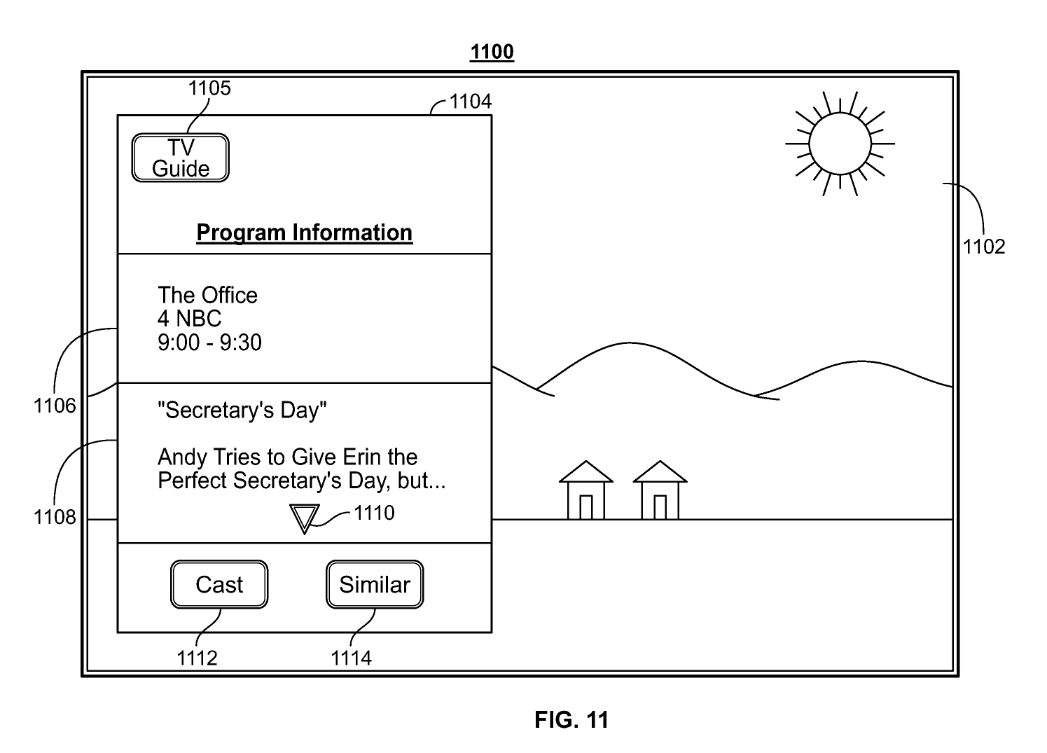

FIG. 10 shows an illustrative media guidance widget screen 1004 allowing navigation through program listings in accordance with embodiments of the invention. In this example, a user has launched a media guidance widget by selecting media guidance widget icon 906 (FIG. 9) or using another appropriate selection or command. Media guidance widget screen 1004 may occupy only part of screen 1000, allowing a program to be viewed in region 1002, as may similarly be the case with the screens shown in FIGS. 11-17. Media guidance widget screen 1004 may include logo 1005, indicating the type of widget and/or provider of the widget. A similar logo may be included in the screens depicted in FIGS. 11-17. Program listings 1008 may be similar to the listings depicted in FIG. 1 and explained in connection therewith. In this example, listings 1008 may include the channel number, network name, and program title for programs that are currently broadcasting at the time the media guidance widget is launched, as indicated by the title “On Now” at the top of widget screen 1004. Highlight region 1006 may mark the currently selected listing in much the same way as highlight region 110 (FIG. 1) marked a listing, and arrow 1010 may provide access to further listings.

In the example depicted in FIG. 10, widget screen 1004 may provide less information than a full-featured interactive media guidance application, in order to provide utility while consuming relatively little in the way of computational resources, thus enabling the media guidance widget to operate in relatively low-memory environments such as television sets. In some embodiments, widget screen 1004 may provide access to listings of only a subset of currently available programs (e.g., for a user's ten most frequently watched channels). In other embodiments, widget screen 1004 may be larger, occupy all of screen 1000, and/or provide most or all of the information and capabilities associated with a traditional, full-featured media guidance application. Flexibility exists with respect to size, complexity, and capabilities for both widgets and full interactive media guidance applications provided by the primary media service provider.

FIG. 11 shows an illustrative program information screen 1104 in accordance with embodiments of the invention. Program information screen 1104 may be displayed at any suitable time, such as when a user presses an “Information” button on user input interface 310 (FIG. 3) while a highlight region is over a program listing. Region 1106 may display series title information, as well as a network and time in which episodes of the series may be broadcast. Additionally, region 1108 may provide information on a particular episode, including an episode title and synopsis. If the synopsis does not fit entirely in region 1108, arrow 1110 may be used to scroll down to view the remainder of the synopsis text. In this example, information is provided for an episode of The Office entitled “Secretary's Day.” It will be understood that program information screen 1104 is merely illustrative, and other information or layouts may be provided. Similarly, program information screen 1104 may be used not only for television episodes, but also for movies and other media such as movie trailers.

Program information screen 1104 may also include button 1112, which may allow the user to access information on the cast of the particular program currently being examined. In some embodiments, button 1112 may provide information on the crew of the program as well. Button 1114 may allow the user to request a list of programs that are similar to the one currently being examined, where similarity may be determined using any one or more suitable criteria, including for example topic, genre, actor, title, or any suitable combination thereof. Screens similar to program information screen 1104 may be also provided in non-widget interactive media guidance applications.

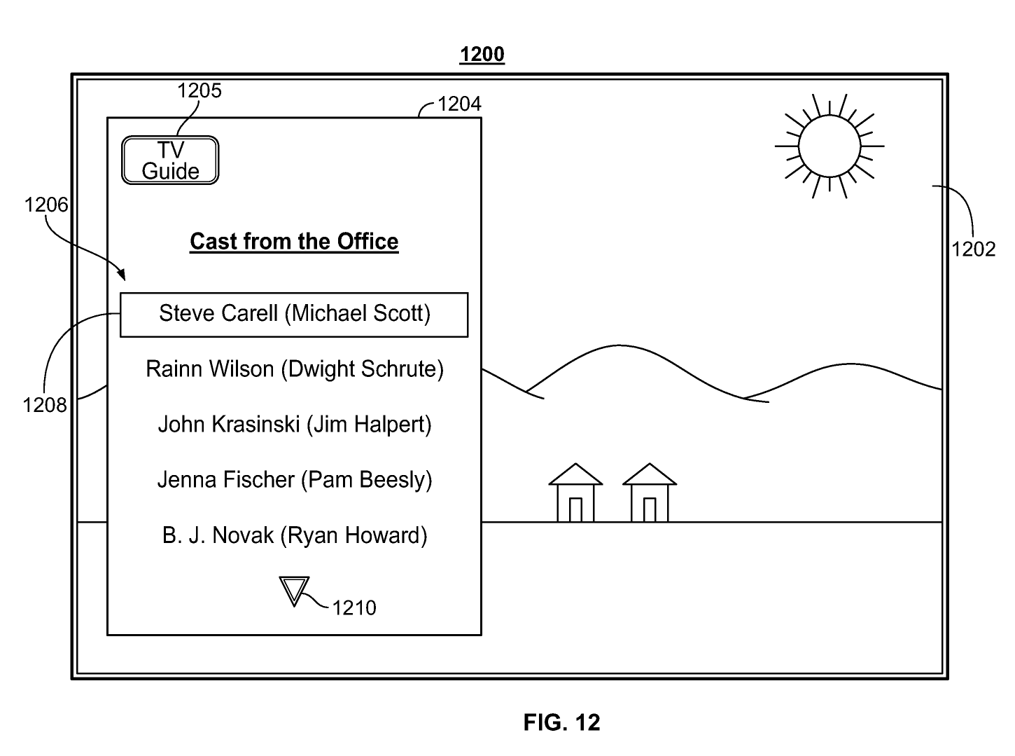

FIG. 12 shows an illustrative cast member list screen 1204 in accordance with embodiments of the invention. Cast member list screen 1204 may be displayed at any suitable time, such as when button 1112 (FIG. 11) is pressed or a similar option is selected from another menu or application. In this example, cast listings 1206 include the name of each actor appearing in The Office, along with the name of the actor's character in parentheses. Because the show contains more actors than can fit in cast member list screen 1204, arrow 1210 may be provided to allow users to view other cast members. In some embodiments, individuals other than cast members, such as directors, producers, writers, and other individuals of interest, may be listed in cast member list screen 1204 or similar screens.

Highlight region 1208 may mark the currently selected cast member. A user may request more information on a particular cast member by pressing an appropriate button on user input interface 310 (FIG. 3), such as an “OK,” “Enter,” “Select,” or “Info” button, while a certain cast member is selected with highlight region 1208. The information may include biographical information, credits, or any other suitable information or combination thereof. Screens similar to cast member list screen 1204 may be also provided in non-widget interactive media guidance applications.

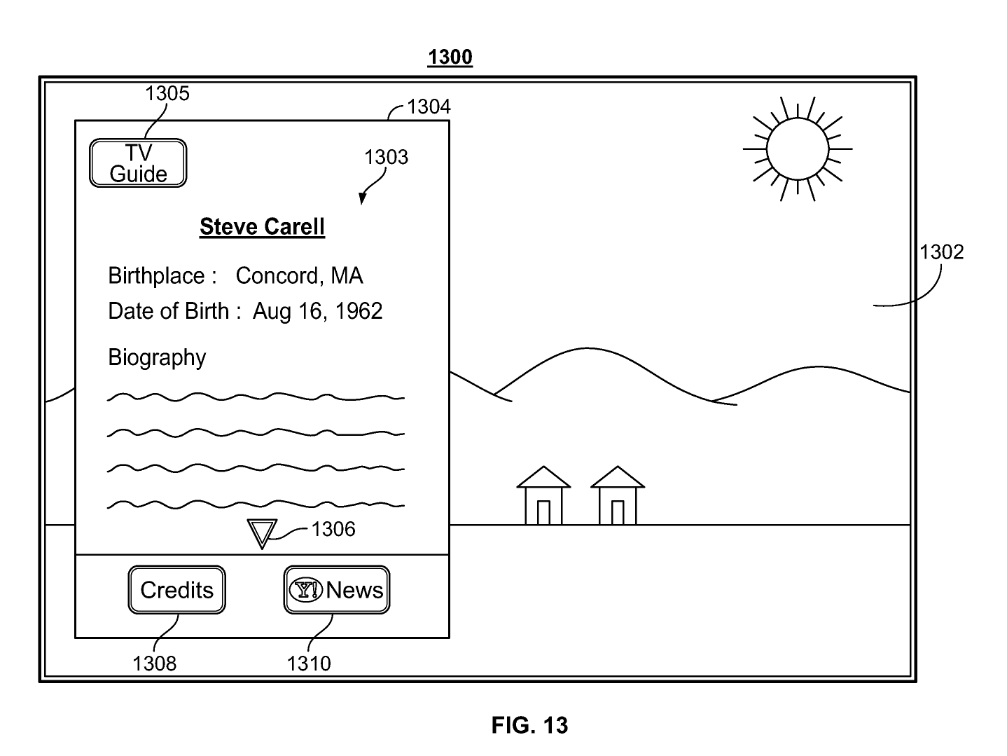

FIG. 13 shows an illustrative actor information screen 1304 in accordance with embodiments of the invention. Actor information screen 1304 may be displayed in response to a user's selection of a cast member in a screen such as cast member list screen 1204, in response to a separate request for actor information through another menu, or in any other suitable manner. In the example depicted in FIG. 13, the user has requested information on the actor Steve Carell. Accordingly, biographical information 1305 may include information such as the actor's birthplace and date of birth, as well as a brief biography. Because even a brief biography of a well-known actor may not fit in a screen such as actor information screen 1304, particularly when actor information screen 1304 is designed to occupy substantially less than the entire screen 1300, arrow 1306 allows the user to view the remainder of the biography by scrolling down.

In accordance with embodiments of the invention, actor information screen 1304 may also include “Credits” button 1308 and “Yahoo! News” button 1310. By selecting “Credits” button 1308, a user may opt to view television series, movies, or other programs the particular actor being examined has participated in, as an actor, director, producer, or in any other capacity. Additionally, “Yahoo! News” button 1310 may allow the user to access news stories relating to the actor being examined, as well as other topics that are more remotely related, such as information relating to the actor's production company, charitable organizations, movies or television series, acquaintances, or any other suitable topic, using the Yahoo! News widget. It will be noted that Yahoo! News button is merely illustrative. Other buttons providing access to other services may be used instead of, or addition to, “Yahoo! News” button 1310. For instance, Yahoo! News button 1310 may be replaced with a button allowing the user to access financial information, such as stock prices, relating to the actor in question (e.g., for the actor's production company), using a financial information widget. Other possibilities are contemplated, such as offering “Yahoo! News” button (or another similar button) in program information screen 1104 (FIG. 11). Screens similar to actor information screen 1304 may be also provided in non-widget interactive media guidance applications.

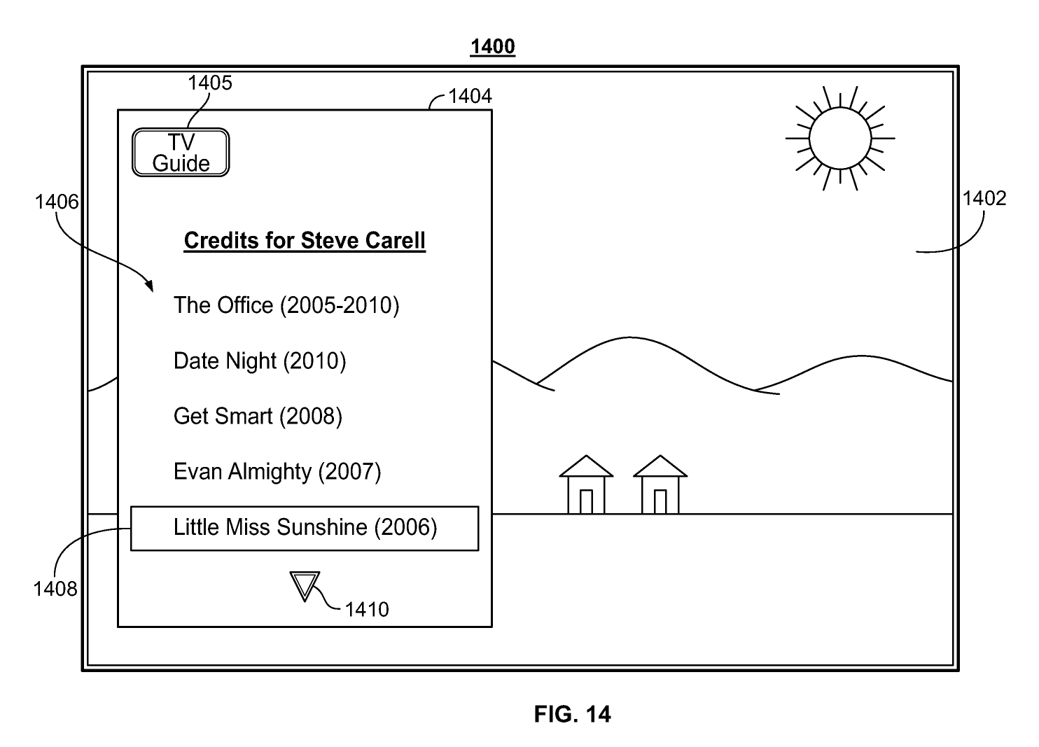

FIG. 14 shows an illustrative actor credits screen 1404 in accordance with embodiments of the invention. Actor credits screen 1404 may be accessed in any suitable way, such as in response to a selection of “Credits” button 1308 (FIG. 13), in response to a separate request for a cast or crew member's credits through another menu, or through any other suitable manner. Actor credits screen 1404 may display titles 1406 for programs that the cast or crew member participated in as an actor, director, writer, producer, or in any other suitable capacity, with the release year of the program indicated in parenthesis. In the example depicted in FIG. 14, titles 1406 are listed not only for movies, but also television series such as The Office, which has run from 2005 to 2010. In some embodiments, titles 1406 may be listed in reverse chronological order. In some embodiments, titles 1406 may be categorized based on type of program (e.g., television program, movie, or commercial), by capacity in which the cast or crew member worked (e.g., actor, director, writer, or producer), by importance of the cast or crew member's role (e.g., primary character or cameo appearance), or in any other suitable manner or combinations thereof. Further titles that cannot fit in actor credits screen 1404 may be viewed by selecting arrow 1410.

Highlight region 1408, which may be similar to highlight region 110 (FIG. 1), may allow a user to select a particular program of interest listed in actor credits screen 1404. A user may request more information on a particular program by pressing an appropriate button on user input interface 310 (FIG. 3), such as an “OK,” “Enter,” “Select,” or “Info” button, while a certain program title is selected with highlight region 1408. The program information may include any suitable information, including but not limited to release date, a quality rating (e.g., thumbs up or down, number of stars, etc.) a synopsis, or any other suitable information. In accordance with embodiments of the invention, selecting a particular program title from credits list 1404 may prompt a widget, guidance application, or system to perform a system query to determine whether the program will be broadcast by the primary media service provider within a certain period of time. If so, the user may be allowed to record the program, set a reminder for the program, or take other suitable actions. If not, the user may be provided options for accessing the program from a third-party data/content source. Further details on this operation will be explained below. Screens similar to actor credits screen 1404 may be also provided in non-widget interactive media guidance applications.

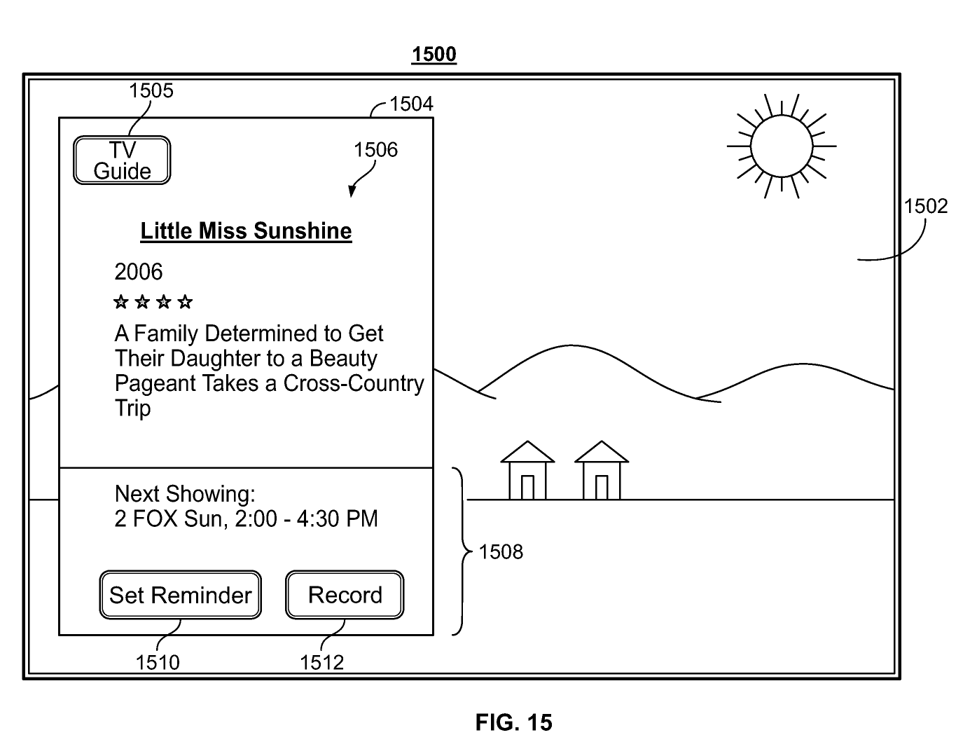

FIG. 15 shows an illustrative program action screen 1504 in accordance with embodiments of the invention. Program action screen may be displayed at any suitable time, such as in response to selecting a particular title in actor credits screen 1404, in response to selecting a program that will be broadcast in the future in a guide screen such as those depicted in FIGS. 1, 2, and 10, in response to selecting a search result from among a list of search results generated based on any one or more suitable search criteria (e.g., actor, title, genre, topic, release date, or any combination thereof), in response to selecting a program from among any suitable list of programs (e.g., a list of recommended programs, or a list of programs similar to another program), or at any other suitable time. Program action screen 1504 may provide program information 1506, which may include any suitable information on the selected program, such as title, release date, quality rating (e.g., thumbs up or down, number of stars, or a numerical score), program synopsis, or any other suitable information or combinations thereof.

In accordance with embodiments of the invention, the program selection leading to the display of program action screen 1504 may prompt the widget, guidance application, or system in which the selection occurs to perform a query (e.g., to media guidance data source 418, to third-party data/content source 424, to a server associated with the widget or guidance application in which the selection occurs, or to any other suitable source) to determine whether the selected program will be broadcast from the primary content provider within a certain pre-determined time period (e.g., one day, one week, or the maximum time period for which upcoming listings is available). If so, then region 1508 of program action screen 1504 may display information on when and on which channel the program will be broadcast, and allow the user to set a reminder for the program using button 1510 or to record the program using button 1512. In some embodiments, the selected action may be performed directly by a widget from which the action was requested. In other embodiments, the action may be performed by another application (e.g., a widget may send a request to a media guidance application informing the guidance application that a program should be recorded or that a reminder should be set for a program). It will be understood that these actions are merely illustrative and other actions may made available to the user, such as to order the movie on-demand during a period during which the movie is available on-demand. Screens similar to program action screen 1504 may be also provided in non-widget interactive media guidance applications.

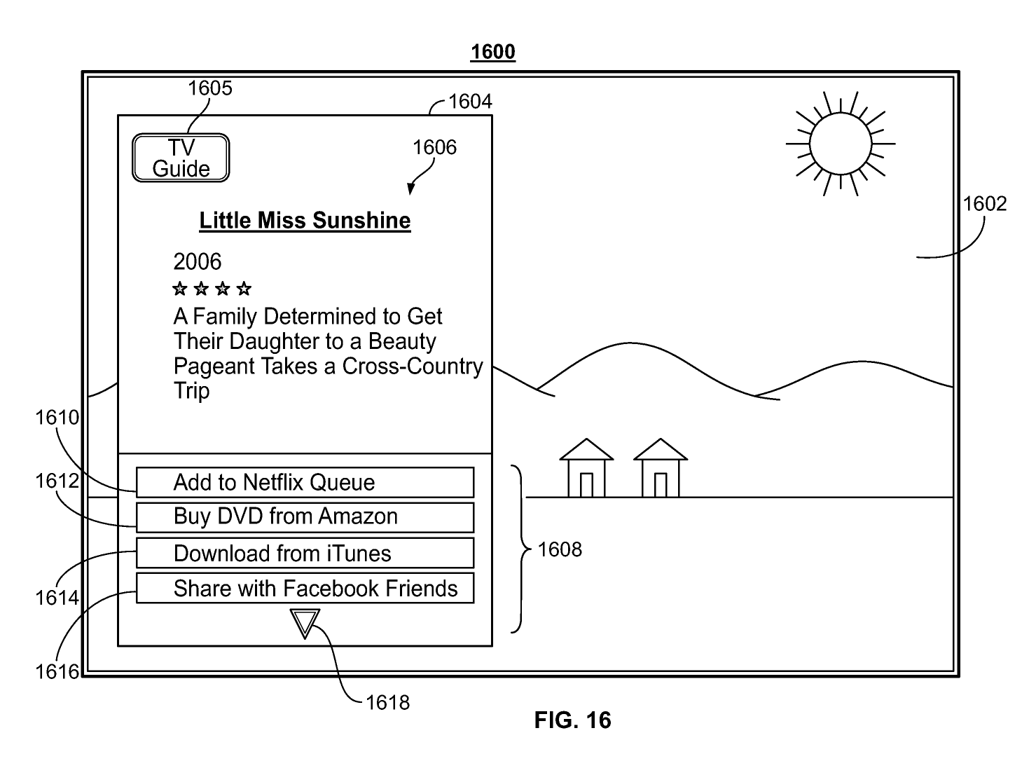

FIG. 16 shows an illustrative third-party access screen 1604 in accordance with embodiments of the invention. Third-party access screen 1604 may be displayed at any suitable time, such as in response to selecting a particular title in actor credits screen 1404, in response to selecting a program that will be broadcast in the future in a guide screen such as those depicted in FIGS. 1, 2, and 10, in response to selecting a search result from among a list of search results generated based on any one or more suitable criteria (e.g., actor, title, genre, topic, release date, or any combination thereof), in response to selecting a program from among any suitable list of programs (e.g., a list of recommended programs, or a list of programs similar to another program), or at any other suitable time or combination thereof. Third-party access screen 1604 may provide program information 1606, which may include any suitable information on the selected program, such as title, release date, quality rating (e.g., thumbs up or down, number of stars, or a numerical score), program synopsis, or any other suitable information or combinations thereof.

In accordance with embodiments of the invention, the program selection leading to the display of third-party access screen 1604 may prompt the widget, guidance application, or system in which the selection occurs to perform a query (e.g., to media guidance data source 418, to third-party data/content source 424, to a server associated with the widget or guidance application in which the selection occurs, or to any other suitable source) to determine whether the selected program will be broadcast from the primary content provider within a certain pre-determined time period (e.g., one day, one week, or the maximum time period for which upcoming listings is available). If not, then region 1608 may provide the user with various options to access the selected program from one or more suitable third-party data/content sources 424 (FIG. 4), as explained in further detail below.

For instance, button 1610 may allow the user to add the program to the user's queue for a media rental service like Netflix, so that a physical DVD of the program may be delivered to the user, possibly after other programs on the queue have been received, watched, and returned by the user. As other examples, button 1612 may allow the user to purchase a DVD of the program from an online marketplace like Amazon, button 1614 may allow the user to download a digital copy of the program from a digital media store like iTunes, and button 1616 may allow the user to share a recommendation for the program with friends that the user is connected to on a social networking site such as Facebook.

Thus, embodiments of the invention may facilitate relatively seamless coordination of different options for obtaining access to a program of interest, not just from the primary media service provider, but from external third-party sources as well. In the example depicted in FIGS. 15 and 16, a preference is given for obtaining access to the program of interest without cost (e.g., from the primary media service provider) even if it requires more waiting time, but other embodiments are possible. For instance, the widget, guidance application, or system could automatically prioritize obtaining access to the program sooner rather than less expensively, or the widget, application, or system may simply present all options to the user for the user's own selection. It will be understood that the types of third-party transactions and particular third parties identified in FIG. 16 are merely illustrative, and other transactions and third parties are contemplated. As examples, third-party access screen 1604 may also allow the user to watch a digital stream of the program from a service such as Netflix or Hulu. Further options for third-party access may be viewed using arrow 1618.

In some embodiments, third-party access options will only be provided in third-party access screen 1604 for third parties for which the user has already supplied necessary account information, such as login information supplied through third-party setup screen 600 or a similar interface, and which the user has already enabled interactions with, using third-party options screen 700 or a similar interface. In other embodiments, third-party access options may be provided for all third parties or for third parties that have been designated as permissible parties to a transaction (e.g., using third-party options screen 700), but if required account information for a particular third party is needed but has not yet been obtained, it will be requested from the user upon user request for a transaction with that third party. Third-party access options may be provided in any suitable order, including but not limited to frequency of prior or recent prior use, a manually determined order set by the user, an order where third parties for which account information has already been supplied listed first, or any other suitable order or combinations thereof. Screens similar to third-party access screen 1604 may be also provided in non-widget interactive media guidance applications.

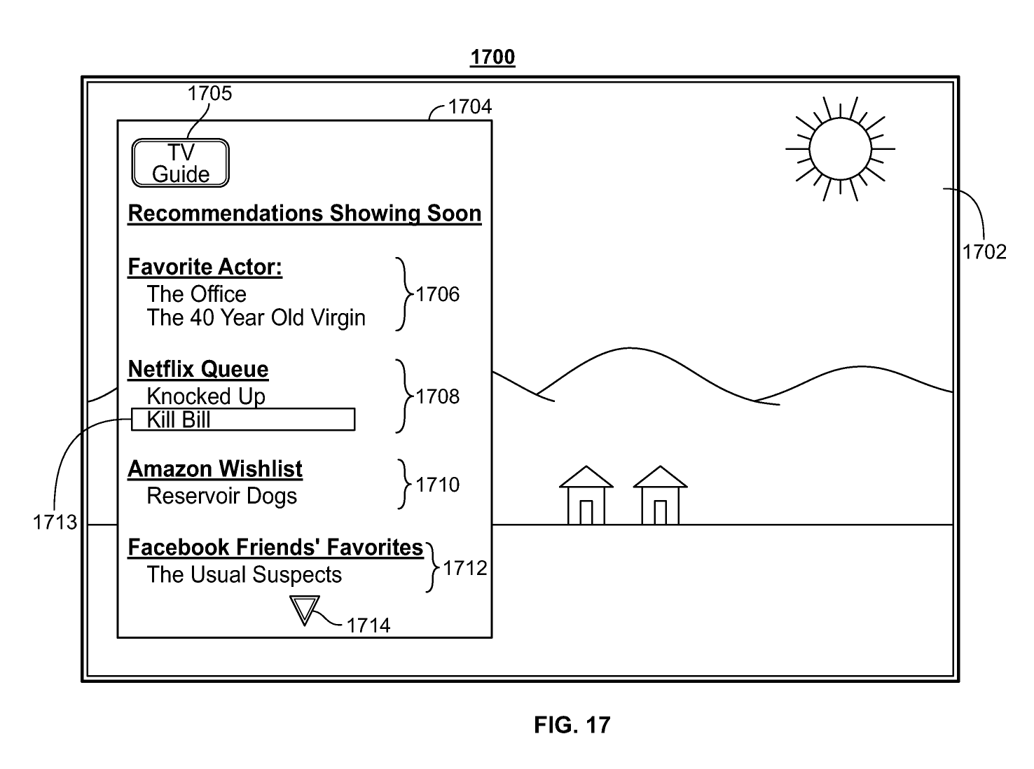

FIG. 17 shows an illustrative recommendations screen 1704 in accordance with embodiments of the invention. Recommendations screen 1704 may be displayed in response to any suitable actions, such as by requesting recommendations through selection of an appropriate option in a widget or guidance application menu, by pressing a dedicated “Recommendations” button on user input interface 310 (FIG. 3), or through any other suitable techniques or combinations thereof. In accordance with embodiments of the invention, a widget, guidance application, or system may generate recommendations for display in recommendations screen 1704 or a similar display through various techniques, including by receiving and processing data from third-party data/content sources 424 (FIG. 4).

For example, recommendations 1706 may be generated based on favorites data that is input into a profile, such as data indicating favorite actors, titles, genres, or topics input using an interface similar to favorites designation screen 800 (FIG. 8). In the example depicted in FIG. 17, recommendations 1706 may include television programs and movies that were identified based on the designation of Steve Carrel as a favorite actor. As other examples, recommendations 1708 may include programs placed on a user's queue for a program rental service such as Netflix, recommendations 1710 may include programs listed on a user's “wish list” (listing items the user would like to receive as gifts from others) from an online retailer such as Amazon, and recommendations 1712 may include programs designated as favorites by individuals who are friends of the user on a social networking site such as Facebook. Thus, embodiments of the invention may advantageously allow a widget, guidance application, or system to aggregate information provided by the user or others to a variety of external services, in order to more effectively tailor recommendations to the user without requiring the user to repeat the same information to the widget, guidance application, or system. It will be noted that these third-party sources are merely illustrative, and other possibilities are contemplated. For instance, recommendations may be generated based on ratings submitted by the user's Facebook friends using a Facebook application (e.g., chosen from all programs with a rating of three or more stars). Further recommendations may be viewed using down arrow 1714.

The user may navigate through the recommendations provided by recommendations screen 1704 in any suitable way, such as by moving highlight region 1713, which may be similar to highlight region 110 (FIG. 1), and by pressing an appropriate button on user input interface 310 (FIG. 3), such as an “OK,” “Enter,” or “Select” button, while a certain program title is selected with highlight region 1713. Once a recommended program is selected, any suitable action may be taken. For example, if the program is currently being broadcast by the user's primary media service provider, the system may automatically tune to the program and display it in region 1702. Alternatively or additionally, the widget, guidance application, or system may provide the user with information on the program or allow the user to perform an action on the program (e.g., using an interface such as program action screen 1504). In some embodiments, such as the one depicted in FIG. 17, only programs that will be broadcast in a certain time period (e.g., one day or one week) by the primary media service provider may be displayed in recommendations screen 1704, as indicated by the heading “Recommendations Showing Soon.”

In other embodiments, recommendations may be provided for programs even if they are not expected to be broadcast in the near future by the user's primary media service provider, and selection of a recommendation may not only prompt display of a screen such as program action screen 1504, but may also prompt display of a screen similar to third-party access screen 1604, allowing the user to access the program from a suitable third-party data/content source.

In some embodiments, recommendations that have been identified for potential display to the user may be filtered, such that only programs that are determined to be available from the primary media service provider, or from third-party content sources that are accessible by the user, are displayed. Such filtering may be performed in any suitable way, such as by comparing a list of potential recommendations to lists of programs that are known to be available from the primary media service provider or third-party content sources that are accessible by the user. Thus, in some embodiments, recommendations screen 1704 may advantageously present to the user only programs that the user is able to access relatively quickly from a known source. Screens similar to recommendations screen 1704 may be also provided in non-widget interactive media guidance applications.

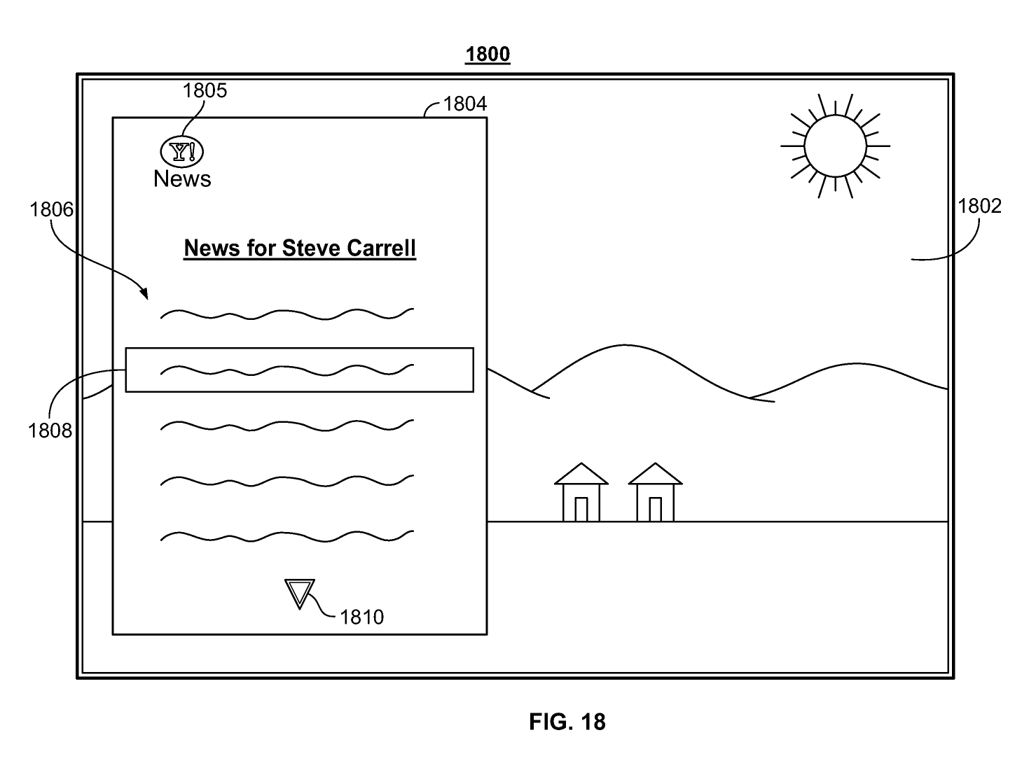

FIG. 18 shows an illustrative actor news screen 1804 in accordance with embodiments of the invention. News screen 1804 may be accessed in any suitable manner, such as by selecting “Yahoo! News” button 1310 in actor information screen 1304, which in the example depicted in FIG. 13 provided information on actor Steve Carrell. Performing such a selection may hide or close the media guidance widget providing actor information screen 1304, and pull up or launch a news widget such as a widget provided by Yahoo! News. The switching to a second widget may be indicated by Yahoo! News logo 1805. Thus, “Yahoo! News” button 1310 may advantageously allow a user to switch from one widget to another in a relatively seamless way, without having to bring up widget navigation menu 901, navigate through it, and manually select the widget desired. It will be appreciated that this concept may be applied to any widgets providing any type of information, not just media guidance or news widgets.

In this example, because news screen 1804 was displayed in response to a selection in actor information screen 1304, which displayed information on Steve Carell, news screen 1804 may advantageously provide headlines 1806 relating to Steve Carell. For instance, headlines 1806 may pertain to professional or personal developments in the actor's life, events related to the actor's projects or programs, developments in the actor's production company, or any other suitable topics or combinations thereof. A headline of interest may be selected by appropriately positioning highlight region 1808, which may be similar to highlight region 110 (FIG. 1) and by pressing an appropriate button on user input interface 310 (FIG. 3), such as an “OK,” “Enter,” or “Select” button, which in turn could display text, pictures, or other media for the corresponding article.

In general, information from a first widget may be shared with a second widget operating on the same user equipment in any suitable way. For instance, the first widget may perform a function call for the second widget whenever the second widget is required to perform an action (e.g., provide content to the user) that may depend on the shared information, in which case the information may be passed as input parameters to the function. Alternatively, the first widget may transmit the information to the second widget using data packets or similar data structures. As another example, information that may later be useful for other widgets may be placed in storage (e.g., in storage 308 (FIG. 3)) on an ongoing basis, for later retrieval by other widgets. As yet another example, the first widget may transmit the shared information to a third-party data/content source 424 (FIG. 4) corresponding to the second widget, so that the third-party data/content source may use the information directly in selecting and formatting content to be sent to the user equipment when required to do so by the second widget. Other possibilities are contemplated, and the invention will generally not be limited by the particular mechanisms used to share information between widgets.

Thus, information from a media guidance widget may be advantageously shared with a news widget in order to better tailor content of the news widget to the user. It will be understood that such sharing of information may also be performed between a widget and a non-widget application or between two non-widget applications.

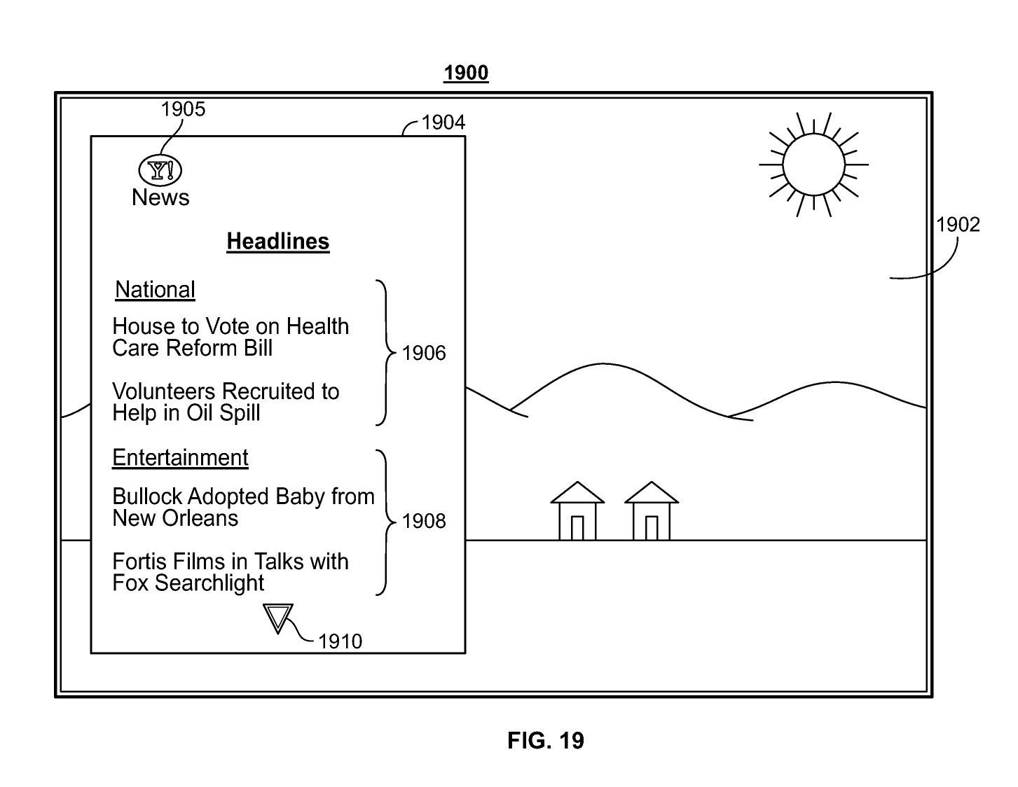

FIG. 19 shows an illustrative news articles screen 1904 in accordance with embodiments of the invention. News articles screen 1904 may be displayed by a news widget, as evidenced by logo 1905, which may be similar to logo 1805 (FIG. 18). News articles screen 1904 may be displayed at any suitable time, such as in response to selecting icon 910 (FIG. 9) or by navigating through a news widget that is launched or pulled up in response to selecting icon 910. In this example, news articles screen 1904 need not be displayed in response to selection of a link embedded in another widget (e.g., a media guidance widget). Rather, news articles screen 1904 may be displayed through stand-alone navigation into and through a news widget. Nevertheless, in accordance with embodiments of the invention, the widget that displays news articles screen 1904 may utilize information shared by other widgets to customize the content that is provided. In the example depicted in FIG. 19, news articles screen 1904 may include national headlines 1906 that may be of general interest to any user, as well as entertainment headlines 1908 that may be selected based on information received for a user from a media guidance widget.

Thus, for example, if Sandra Bullock has been flagged as a favorite actor because of information received through favorites designation screen 800, or because information on her was viewed using actor information screen 1304 or a similar interface, or because the user's viewing history indicates frequent viewing of programs featuring Sandra Bullock, or for any other suitable reason, headlines 1908 may be tailored to include headlines corresponding to Sandra Bullock. In the example depicted in FIG. 19, the headlines relate to Sandra Bullock's adoption of a baby and a possible partnership between Fortis Films (Bullock's production company) and For Searchlight. Identification of relevant headlines may be performed in any suitable way, such as using keyword searching of articles, tags for such news articles, or any other suitable information or combinations thereof. It will be understood that other ways of sharing information may be possible. For instance, the fact that Sandra Bullock seems to be a favorite actor of the user may be deduced from information on the user's Facebook profile (accessed through a Facebook widget), the user's Netflix queue (accessed through a Netflix widget), or any other suitable source. As discussed in connection with FIG. 18, information may be shared between two widgets operating on the same user equipment using any of various suitable techniques. Also, information may be shared between a widget and a non-widget application (in either direction), or between two non-widget applications.

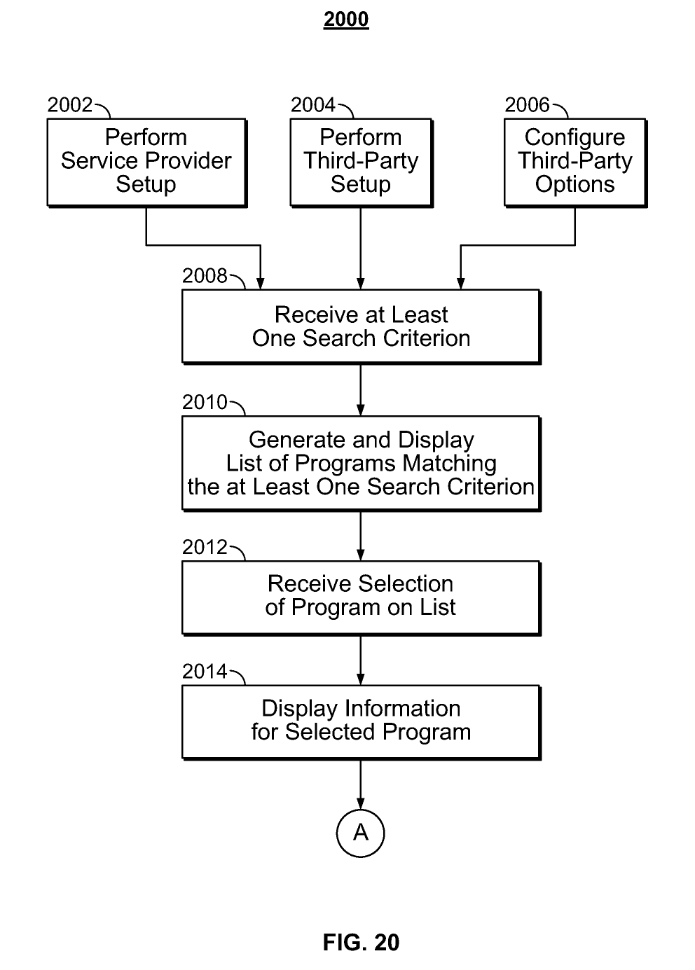

FIG. 20 shows an illustrative flow chart of a first part 2000 of a process for providing an opportunity to perform an action on a program or to access the program from an third-party media content source in accordance with embodiments of the invention. In step 2002, service provider setup may be performed to receive information such as a user's primary media service provider and zip code, using any suitable interface such as service provider setup screen 500 (FIG. 5). In step 2004, third-party setup may be performed to receive information such as third-party account login (e.g., username and password) information, using any suitable interface such as third-party setup screen 600 (FIG. 6). Additionally, third-party options may be configured in step 2006 in order to determine which third parties the user wishes to share information with, using any suitable interface such as third-party options screen 700. Steps 2002, 2004, and 2006 may be performed in any order relative to each other, and in certain embodiments need not all be performed in order to proceed to step 2008.

In step 2008, at least one search criterion may be received. For instance, a search may be requested using “Credits” button 1308 (FIG. 13), in which case the criterion would be the identity of the cast or crew member (e.g., actor) for which credits are requested. As another example, a stand-alone search may be performed by a user requesting programs corresponding to a certain actor, title, genre, topic, or another other suitable criterion or combination thereof. As another example, a search may be performed for programs similar to a given program, as determined in any suitable way, for example using “Similar” button 1114 (FIG. 11). Additionally, a search for recommendations may be performed, according to any suitable criteria or using any suitable information, including third-party data/content sources.

In step 2010, a list of programs matching the at least one search criterion may be generated and displayed in any suitable manner, such as using credits screen 1404 (FIG. 14) or recommendations screen 1704 (FIG. 17). The list may be generated using any suitable sources, including third-party data/content sources 424. In some embodiments, programs that have been identified for potential display to the user may be filtered, such that only programs that are determined to be available from the primary media service provider, or from third-party content sources that are accessible by the user, are displayed. Such filtering may be performed in any suitable way, such as by comparing a list of the programs that may be displayed to lists of programs that are known to be available from the primary media service provider or third-party content sources that are accessible by the user. Thus, in some embodiments, step 2010 may present to the user only programs that the user is able to access relatively quickly from at least one of several known sources.

In step 2012, a selection of a program on the displayed list may be received in any suitable way, such as using a highlight region similar to highlight region 1408 (FIG. 14) or highlight region 1713 (FIG. 17). In step 2014, information for the selected program may be displayed in any suitable manner, such as using program action screen 1504 (FIG. 15), third-party access screen 1604 (FIG. 16), or in any other suitable manner. The information displayed may include, for example, program title, release date, rating, synopsis, or any other suitable data or combinations thereof. Process 2000 may then proceed to link “A.”

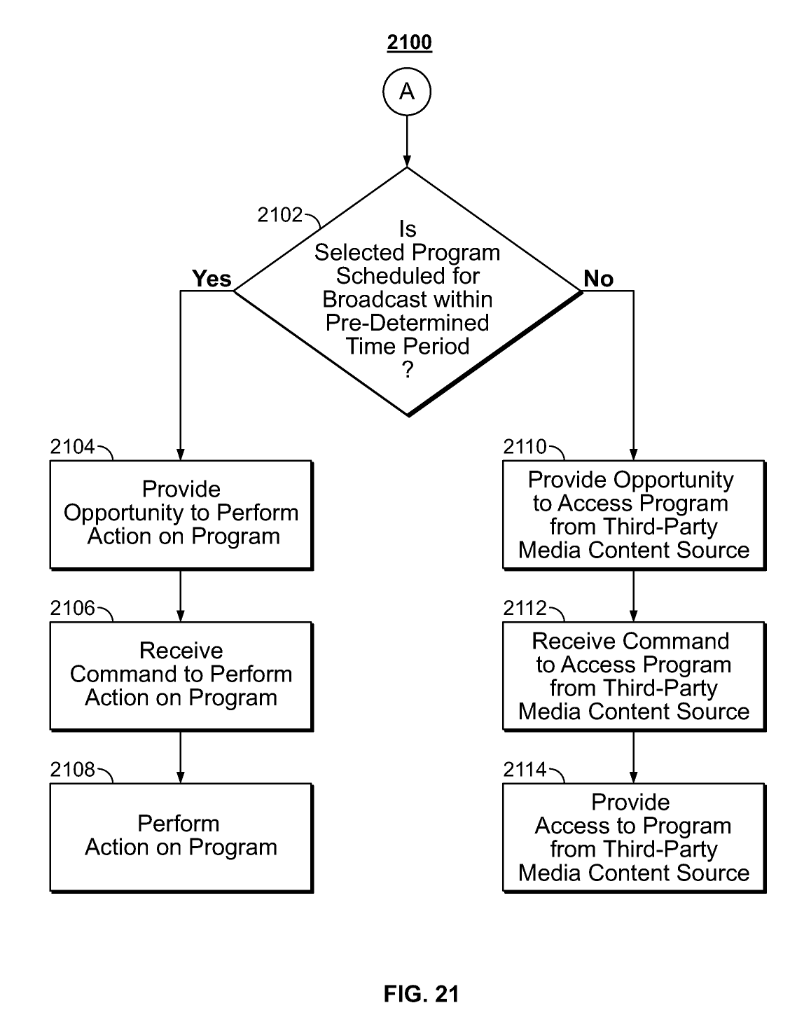

The process started in FIG. 20 may continue in FIG. 21, through second part 2100, entering via link “A.” At step 2102, it may be determined whether the selected program is scheduled for broadcast (e.g., by the user's primary content service provider) within a pre-determined time period (e.g., one day or one week). This information may be obtained in any suitable way, such as by querying media guidance data source 418. If the program is scheduled for broadcast within the time period, an opportunity to perform an action on the program (e.g., to record or set a reminder for it) may be provided in any suitable manner, such as via program action screen 1504 (FIG. 15) or a similar interface. If a command is then received to perform a particular action on the program at step 2106 (e.g., through selection of “set Reminder” button 1510 or “Record” button 1512 (FIG. 15)), the action may be performed at step 2108.

If, on the other hand, it is determined that the program will not be broadcast during the pre-determined time period, an opportunity to access the program from a third-party media content source may be provided in any suitable manner, such as by using third-party access screen 1604 (FIG. 16) or a similar interface. In accordance with embodiments of the invention, the user may thus be provided with options to rent, purchase, download, or otherwise access the program from sources other than the user's primary media service provider. If a command to access the program from any of the available third-party media content sources is then received at step 2112 (e.g., by receiving a selection of any of buttons 1610, 1612, and 1614 (FIG. 16)), access to the selected program may be provided in step 2114. In practice, steps may be added, deleted, re-ordered, or modified in either or both of FIGS. 20 and 21 without deviating from the spirit or scope of the invention.

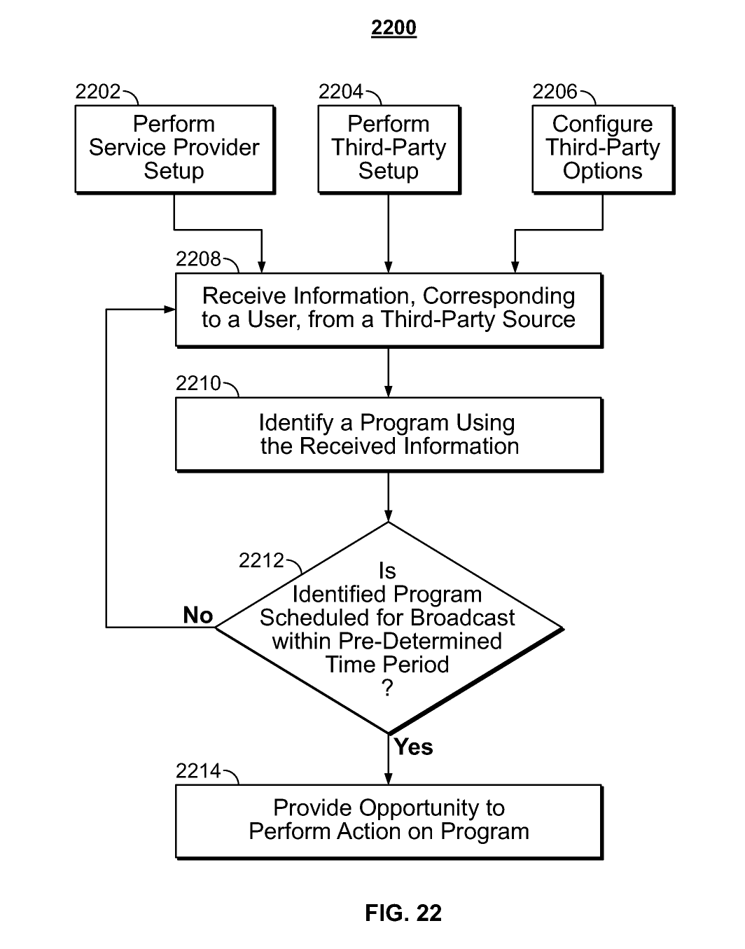

FIG. 22 shows an illustrative flow chart of a process 2200 for providing an opportunity to perform an action on a program that is identified using information from a third-party data source in accordance with embodiments of the invention. Steps 2202, 2204, and 2206 may be similar to steps 2002, 2204, and 2006, respectively (FIG. 22) and are not described in detail. At step 2208, information corresponding to a user may be received from a third-party source. For example, the third-party source may allow users to rent, purchase, download, or view programs. The third-party source may also provide social networking services or any other suitable services.

At step 2210, a program may be identified using the received information in any suitable way. For instance, the movie “Little Miss Sunshine” might be identified based on information received at step 2208 that the user had placed the movie on their Netflix queue. As another example, a television program may be identified based on the fact that the user put a DVD box set containing at least one season of episodes for that program on their Amazon wishlist. Other examples of using information from third-party sources to identify programs are contemplated. In some embodiments, the media guidance application or widget identifying the program may confirm that the identified program is available from the primary media service provider or from third-party content sources that are accessible by the user, and discard the program if it is not available from any such sources. Such confirmation may be performed in any suitable way, such as by searching for the program of interest in lists of programs that are known to be available from the primary media service provider or third-party content sources that are accessible by the user. Thus, in some embodiments, process 2200 may present to the user only programs that the user is able to access relatively quickly from at least one of several known sources.

At step 2212, it may be determined whether the identified program is scheduled for broadcast (e.g., by the user's primary media service provider) within a certain pre-determined time period (e.g., one day or one week). This determination may be performed in any suitable manner, such as by using information from media guidance data source 418 (FIG. 4). If the program is scheduled for broadcast within the time period, the user may be provided with an opportunity to perform an action on the program in step 2214. For instance, the program may be listed on recommendations screen 1704 or a similar display. Selection of the program from recommendations screen 1704 or a similar display may cause display of an interface similar to program action screen 1504, which may allow the user to set a reminder for the program or to record the program. If, on the other hand, the program is not scheduled for broadcast within the time period, process 2200 may return to step 2208 to identify other programs of interest to the user that may be broadcast within the pre-determined time period.

It will be noted that process 2200 is merely illustrative, and other variations are contemplated (e.g., by removing, adding, modifying, or re-ordering steps). For instance, in some embodiments, step 2212 may be omitted, such that any program identified using third-party information in steps 2208 and 2210 may be presented to the user as a recommendation, even if the user may only access the program from a third-party source. Recommendations may be presented one at a time, instead of in a list. Alternatively, potential recommendations may be ranked according to any suitable metric, and the highest-ranking potential recommendations (up to a certain maximum number) may be presented to the user.

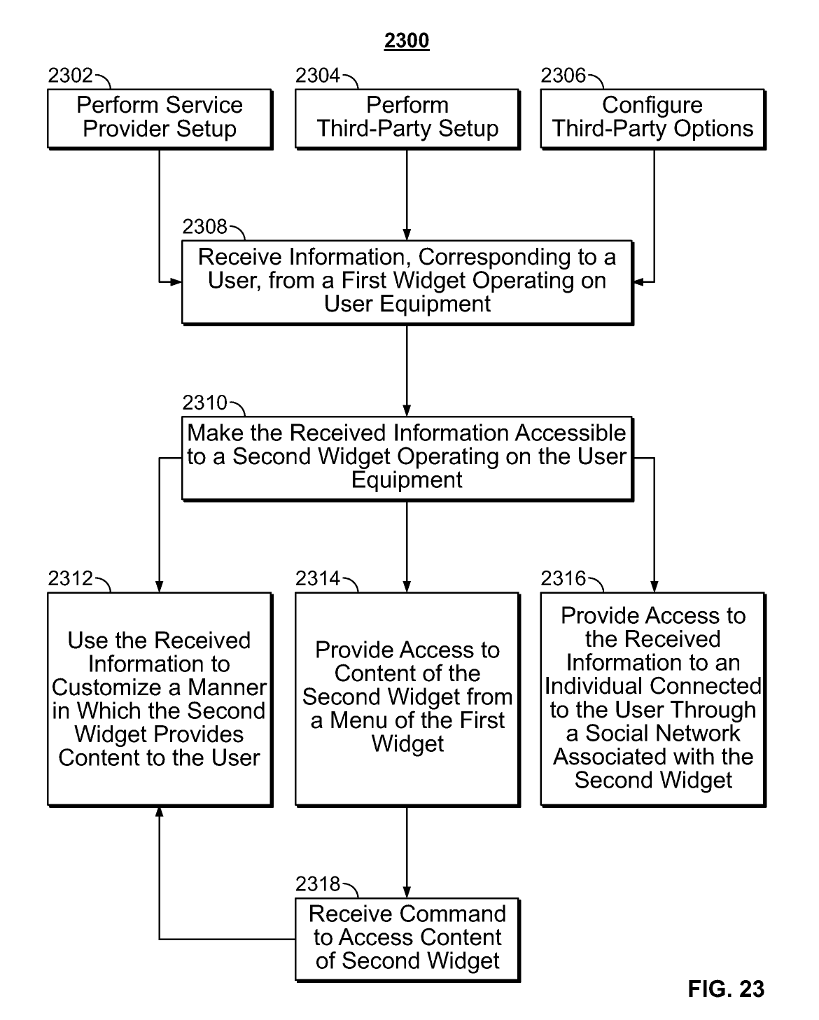

FIG. 23 shows an illustrative flow chart of a process 2300 for sharing information between a plurality of widgets operating on user equipment in accordance with embodiments of the invention. Steps 2302, 2304, and 2306 may be similar to steps 2002, 2004, and 2006, respectively (FIG. 20) and are not described in detail. At step 2308, information corresponding to a user may be received from a first widget operating on user equipment. For instance, information may be received from a media guidance widget indicating interest in a particular actor. At step 2310, the received information may be made accessible to a second widget operating on the same user equipment as the first widget. At this point, one of several steps may be performed, depending on system and application configuration, as well as actions taken by the user.

At step 2312 the information received from the first widget may be used to customize a manner in which the second widget provides content to the user. For instance, if the second widget is a news widget, information from the first widget that suggests an interest in a particular actor may cause the second widget to identify at least one news article relating to the actor for presentation to the user. Such presentation of news articles may be performed, for example, using an interface similar to news articles screen 1904 (FIG. 19).

Alternatively, at step 2314, access to content of the second widget may be provided from a menu of the first widget, such as through “Yahoo! News” button 1310 of actor information screen 1304 (FIG. 13). If a command to access the content of the second widget is received at step 2318 (e.g., through selection of “Yahoo! News” button 1310 (FIG. 13)), process 2300 may again proceed to step 2312, where the received information may be used to customize a manner in which the second widget provides content to the user. For instance, continuing with the example where the second widget is a news widget, a display similar to actor news screen 1804 (FIG. 18) may be provided to the user, providing news articles relating to a given actor that the user has expressed interest in, according to the information received from the first widget.

As yet another alternative, at step 2316, access to the received information may be provided to an individual connected to the user through a social network associated with the second widget. For example, if the second widget is a Facebook widget and the received information indicates that the user has rated the movie “Little Miss Sunshine” highly, the Facebook widget may share that fact with some or all of the user's Facebook friends through a Facebook status update, through a Facebook message, using a Facebook application focusing on television programs or movies, or through any other suitable means.

It will be noted that the depicted uses of the information received in step 2308 are merely illustrative, and other uses are possible. In practice, steps may be added, removed, modified, or re-ordered in process 2300 without deviating from the spirit or scope of the invention.

It is to be understood that while certain forms of the present invention have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein.

1. A method for providing an opportunity to perform an action on media content or to access the media content from a third-party media content source, the method comprising:
receiving a selection of the media content from among a list of media content;
determining whether the selected media content is available from a first media content source within a pre-determined time period;
if the selected media content is available from the first media content source within the pre-determined time period, providing the opportunity to perform the action on the media content; and
if the selected media content is not available within the pre-determined time period, providing an opportunity to access the media content from the third-party media content source, wherein the third-party media content source is different from the first media content source.

2. The method of claim 1 wherein providing the opportunity to perform the action on the media content comprises providing an opportunity to set a reminder for the media content.

3. The method of claim 1 wherein providing the opportunity to perform the action on the media content comprises providing an opportunity to record the media content.

4. The method of claim 1 further comprising:
receiving at least one search criterion; and
generating the list of media content by identifying media content that matches the at least one search criterion.

5. The method of claim 4 wherein a criterion of the at least one criterion is selected from the group consisting of: actor, genre, topic, title, channel, maturity rating, and quality rating.

6. The method of claim 4 wherein generating the list of media content comprises identifying media content that match the at least one search criterion and that are available from the first media content source within the pre-determined time period or accessible from the third-party media content source.

7. The method of claim 1 wherein providing the opportunity to access the media content from the third-party media content source comprises providing an opportunity to purchase a physical copy of the media content from the third-party media content source.

8. The method of claim 1 wherein providing the opportunity to access the media content from the third-party media content source comprises providing an opportunity to download a digital copy of the media content from the third-party media content source.

9. The method of claim 1 wherein providing the opportunity to access the media content from the third-party media content source comprises providing an opportunity to rent the media content from the third-party media content source.

10. The method of claim 1 further comprising:
receiving a command to access the media content from the third-party media content source; and
accessing the media content from the third-party media source using a widget.

11. A system for providing an opportunity to perform an action on a media content or to access the media content from a third-party media content source, the system comprising user equipment configured to:
receive a selection of the media content from among a list of media content;
determine whether the selected media content is available from a first media content source within a pre-determined time period;
if the selected media content is available from the first media content source within the pre-determined time period, provide the opportunity to perform the action on the media content; and
if the selected media content is not available within the pre-determined time period, provide an opportunity to access the media content from the third-party media content source, wherein the third-party media content source is different from the first media content source.

12. The system of claim 11 wherein the user equipment is further configured to provide an opportunity to set a reminder for the media content.

13. The system of claim 11 wherein the user equipment is further configured to provide an opportunity to record the media content.

14. The system of claim 11 wherein the user equipment is further configured to:
receive at least one search criterion; and
generate the list of media content by identifying media content that match the at least one search criterion.

15. The system of claim 14 wherein a criterion of the at least one criterion is selected from the group consisting of: actor, genre, topic, title, channel, maturity rating, and quality rating.

16. The system of claim 14 wherein the user equipment is further configured to generate the list of media content by identifying media content that matches the at least one search criterion and that are available from the first media content source within the pre-determined time period or accessible from the third-party media content source.

17. The system of claim 11 wherein the user equipment is further configured to provide an opportunity to purchase a physical copy of the media content from the third-party media content source.

18. The system of claim 11 wherein the user equipment is further configured to provide an opportunity to download a digital copy of the media content from the third-party media content source.

19. The system of claim 11 wherein the user equipment is further configured to provide an opportunity to rent the media content from the third-party media content source.

20. The system of claim 11 wherein the user equipment is further configured to:
receive a command to access the media content from the third-party media content source; and
access the media content from the third-party media source using a widget.

21-30. (canceled)
